(19) United States
(12) Patent Application Publication
(10) Pub. No.: US 2020/0056045 A1
(43) Pub. Date: Feb. 20, 2020

(54) STORAGE-STABLE ONE-PART ROOM-TEMPERATURE CURABLE COMPOSITIONS ON THE BASIS OF ORGANOSILICON COMPOUNDS

(71) Applicant: Wacker Chemie AG, Munich (DE)

(72) Inventors: Torsten SIXT, Mehring (DE); Jian NIE, Shanghai (CN)

(73) Assignee: Wacker Chemie AG, Munich (DE)

(21) Appl. No.: 16/346,378

(22) PCT Filed: Oct. 31, 2016
(86) PCT No.: PCT/CN2016/104015

§ 371 Date: Apr. 30, 2019

(51) Int. Cl. C08L 83/06; C08G 77/16; C08K 5/00; C08K 5/5419; C08K 3/36; C08K 5/57

(52) U.S. Cl. CPC C08L 83/06; C08G 77/16; C08K 5/0025; C08L 2312/00; C08K 3/36; C08K 5/57; C08K 5/5419

(57) ABSTRACT

One-part room-temperature curable compositions (RTV-1 compositions) based on organosilicon compounds have improved storage stability and excellent physical properties, and contain (A) at least one organosilicon compound containing condensable groups, (B) at least one curing agent comprising a combination of n-propyltriacetoxysilane and methyltriacetoxysilane, and (C) at least one curing catalyst comprising an organotin compound. The curing agent is a combination of n-propyltriacetoxysilane and methyltriacetoxysilane reduces the tendency of the composition to crystallize without impairing the chemical and physical properties of the composition.

### CROSS REFERENCE TO RELATED APPLICATIONS

This application is the U.S. National Phase of PCT Appln. No. PCT/CN2016/104015 filed Oct. 31, 2016, the disclosure of which is incorporated in its entirety by reference herein.

### BACKGROUND OF THE INVENTION

### 1. Field of the Invention

The present invention relates to one-part room-temperature curable compositions (RTV-1 compositions) based on of organosilicon compounds, having improved storage stability and excellent physical properties.

### 2. Description of the Related Art

Silicone sealants have become vital components in building and assembly in today's demanding world. More importantly, they have become indispensable products in essentially all key industries.

Curing of RTV-1 compositions based on organosilicon compounds is initiated at room temperature when they are exposed to atmospheric humidity. This allows for the production of ready-to-use silicone compositions which do not require additional preparation steps such as mixing of two or more components prior to use or additional steps and equipment for inducing curing such as heating or radiation. This makes RTV-1 compositions based on organosilicon compounds especially easy, economical and time-saving to use in a variety of applications such as, for example, in building construction, windows and glazing applications, sanitary applications, fittings, roofing, DIY applications, etc.

However, one of the major drawbacks of conventional RTV-1 compositions based on organosilicon compounds is their poor storage stability. One of the most commonly used standard curing agents for RTV-1 compositions based on organosilicon compounds is methyltriacetoxysilane which has a melting point above room temperature. During storage, methyltriacetoxysilane crystallizes, thus, significantly impairing the quality and function of the product.

U.S. Pat. No. 4,301,269 A discloses room-temperature curable organopolysiloxane compositions in which the curing agent comprises acyloxy silanes in which the acyloxy groups are partially replaced with oxyethyleneacyloxy groups in order to inhibit crystallization. However, using these types of curing agents leads to an increased mass loss during vulcanization.

U.S. Pat. No. 4,116,935 A discloses room-temperature curable organopolysiloxane compositions in which the curing agent comprises acetoxy silane oligomers in order to inhibit crystallization. However, increased amounts of acetoxy silane oligomers lead to an undesired decrease of the skin formation time and to increased viscosity.

DE 3143705 A1 discloses room-temperature curable organopolysiloxane compositions that contain formic acid in order to inhibit crystallization. However, the disadvantage of formic acid is that it significantly decreases the skin formation time of the composition.

### Technical Problem

Taking account of the technical drawbacks described above, it has been an object to provide a one-part room-temperature curable composition based on organosilicon compounds which has improved storage stability without impairing skin formation time, viscosity or other physical properties.

### SUMMARY OF THE INVENTION

This problem has been solved by the claimed subject-matter, namely, by using a curing agent that comprises a combination of n-propyltriacetoxysilane and methyltriacetoxysilane which significantly reduces the tendency of the composition to crystallize while maintaining the chemical and physical properties of composition.

### DETAILED DESCRIPTION OF THE PREFERRED EMBODIMENTS

For the purposes of the present invention, the expression “one-part” is intended to mean that the components of the silicone composition are stored together as a pre-made mixture in a single package.

For the purposes of the present invention, the expression “curing agent” is intended to mean a compound or combination of compounds that comprise reactive groups that are capable of reacting with functional groups of the organosilicon compound.

The curing agent is thereby incorporated into the structure of the resultant (cured) silicone elastomer.

For the purposes of the present invention, the expression “curing catalyst” is intended to mean a compound or combination of compounds that is capable of catalyzing the condensation reaction of organosilicon compound and curing agent in the presence of moisture or water.

For the purposes of the present invention, the expression “RTV” means room-temperature vulcanizable or, synonymously, room-temperature curable.

For the purposes of the present invention, unless otherwise specified the expression “room temperature” is intended to mean a temperature of 23±2° C.

For the purposes of the present invention, the expression “condensable radicals” or “condensable groups” is also intended to mean those radicals or groups which concomitantly include any preceding hydrolysis step.

For the purposes of the present invention, the expression “condensation reaction” is also intended to encompass concomitantly any preceding hydrolysis step.

For the purposes of the present invention, the expression “skin formation time” defines the period of time until a thin elastic film has been built on the surface of the composition, differing from the material beneath it. Once the skin formation time has been exceeded adhesion of the composition to substrates is significantly worsened. Accordingly, the skin formation time is an indicator for the maximum time in which the composition must be applied to the substrates. For example, if the skin formation time is too low, applications in warm and humid environments become problematic or even impossible as curing is induced too quickly.

The expressions “substituted” or “having one or more substituents” as used herein means that one or more hydrogen atoms of a chemical compound or chemical group are replaced with an atom or group of atoms other than hydrogen. Unless otherwise indicated, the substituent is preferably selected from halogenide (such as, for example, fluoride, chloride, bromide, iodide), alkyl (such as, for example, methyl, ethyl, n-propyl, iso-propyl, n-butyl, sec-butyl, iso-butyl, tert-butyl, n-amyl, and tert-amyl), hydroxyl, alkoxy (such as, for example, methoxy, ethoxy), aryl (such as, for example, phenyl, tolyl, xylyl, 1-, or 2-naphthyl, 1-, 2-, 3-, 4-, or 9-phenanthryl, 1-, 2-, or 9-anthracyl), alkenyl (such as, for example, vinyl, allyl, 1-butenyl), benzoyl, acetyl, formyl, nitro, (primary, secondary or tertiary) amino, cyano, mercapto, carboxyl, carboxylate (such as, for example, methyl carboxylate, ethyl carboxylate), carbamoyl, N,N-alkylcarbamoyl, sulfonyl and sufinyl.

For the purposes of the present invention, the term “comprising” also includes the more limited alternative “consisting of” the subsequently-described components, which means that no further components or constituents may be present.

The present invention thus relates to a one-part room-temperature curable composition comprising:

(A) at least one organosilicon compound containing condensable groups;

(B) at least one curing agent comprising a combination of n-propyltriacetoxysilane and methyltriacetoxysilane; and

(C) at least one curing catalyst comprising an organotin compound.

Component (A)

The organosilicon compound of component (A) may be any organosilicon compound known in the art that is suitable to undergo condensation curing (cross-linking via condensation reaction).

Preferably, the organosilicon compound of component (A) contains two or more condensable groups per molecule of the organosilicon compound, wherein the condensable groups are selected from the hydroxyl group, acyloxy groups, or combinations thereof.

Preferably, the organosilicon compound is a polymer or copolymer comprising siloxane units, i.e. ≡Si—O—Si≡ structures, silcarbane units, i.e. ≡Si—R″—Si≡ structures, or combinations thereof, wherein R″ is a divalent hydrocarbon radical which may be substituted or unsubstituted, and wherein one or more carbon atoms of the hydrocarbon radical may optionally be replaced with heteroatoms selected from the group consisting of O, S and N. More preferably, the organosilicon compound is an organopolysiloxane, i.e. a polymer consisting of siloxane units.

In one embodiment, the organosilicon compound comprises units of formula (I):

RₐY_{b}SiO_{(4-a-b)/2} (I),

wherein

R can be identical or different and is a substituted or unsubstituted hydrocarbon radical, wherein one or more carbon atoms of the hydrocarbon radical may optionally be replaced with oxygen atoms,

Y can be identical or different and is a hydroxy radical or acyloxy radical,

a is 0, 1, 2, or 3, preferably 1 or 2, and

b is 0, 1, 2, or 3, preferably 0, 1, or 2, particularly preferably 0, with the proviso that the sum of a and b is less than or equal to 3 and at least two Y radicals are present per molecule of the organosilicon compound.

The sum of a and b in formula (I) is preferably 2 or 3.

Preferably, R is a monovalent hydrocarbon radical having from 1 to 18 carbon atoms, wherein the hydrocarbon radical is optionally substituted with one or more substituents. Preferably, the substituents are selected from the group consisting of halogen atoms, amino groups, ether groups, ester groups, epoxy groups, mercapto groups, cyano groups, and (poly)glycol radicals, the latter being composed of oxyethylene units and/or oxypropylene units. More preferably, R is an alkyl radical having from 1 to 12 carbon atoms. Even more preferably, R is a methyl radical.

The radical R may also be a divalent radical which, for example, bonds two silyl groups to one another.

Examples of radicals R are alkyl radicals such as methyl, ethyl, n-propyl, isopropyl, 1-n-butyl, 2-n-butyl-, isobutyl, tert-butyl, n-pentyl, isopentyl, neopentyl, and tert-pentyl; hexyl radicals such as n-hexyl; heptyl radicals such as n-heptyl; octyl radicals such as n-octyl, iso-octyl, and 2,2,4-trimethylpentyl; nonyl radicals such as n-nonyl; decyl radicals such as n-decyl; dodecyl radicals such as n-dodecyl; octadecyl radicals such as n-octadecyl; cycloalkyl radicals such as cyclopentyl, cyclohexyl, cycloheptyl and methylcyclohexyl; alkenyl radicals such as vinyl, 1-propenyl, and 2-propenyl; aryl radicals such as phenyl, naphthyl, anthryl, and phenanthryl; alkaryl radicals such as o-, m-, p-tolyl, xylyl and ethylphenyl; and aralkyl radicals such as the benzyl and α- and β-phenylethyl.

Examples of substituted radicals R are methoxyethyl, ethoxyethyl, and ethoxyethoxyethyl.

Examples of divalent radicals R are polyisobutylenediyl radicals and propanediyl-terminated polypropylene glycol radicals.

Preferably, Y is a an acetoxy radical.

In a further embodiment, the organosilicon compound is an organopolysiloxane of formula (II):

Y_{3-f}R_{f}SiO—(SiR₂O)ₑ—SiR_{f}Y_{3-f} (II),

wherein

each of R and Y can be identical or different and are the same as defined above for formula (I),

e is from 30 to 3000, and

f is 1 or 2.

f is preferably 2 if Y is hydroxy, and f is preferably 1 or 0 if Y is acyloxy.

Preferably, the organosilicon compound is selected from the group consisting of
(AcO)₂MeSiO[SiMe₂O]₂₀₀₋₂₀₀₀SiMe(OAc)₂,
(HO)Me₂SiO[SiMe₂O]₂₀₀₋₂₀₀₀SiMe₂(OH),
(HO)MeViSiO[SiMe₂]₂₀₀₋₂₀₀₀SiMeVi(OH),
(AcO)₂ViSiO[SiMe₂O]₂₀₀₋₂₀₀₀SiVi(OAc)₂,
(AcO)₂EtSiO[SiMe₂O]₂₀₀₋₂₀₀₀SiEt(OAc)₂,
(AcO)₂PrSiO[SiMe₂O]₂₀₀₋₂₀₀₀SiPr(OAc)₂,
(AcO)₂MeSiO[SiMe₂O]₂₀₀₋₂₀₀₀SiPr(OAc)₂,
(AcO)₂PrSiO[SiMe₂O]₂₀₀₋₂₀₀₀SiEt(OAc)₂,
and combinations thereof,

wherein Me is a methyl radical, Et is an ethyl radical, Pr is a n-propyl radical, Vi is a vinyl radical, and Ac is an acetoxy radical.

The viscosity of the organosilicon compound is preferably from 100 to 1,000,000 mPa·s, more preferably from 1,000 to 350,000 mPa·s, measured at a temperature of 25° C. The viscosity can be determined according to DIN 53019-1 using a plate-cone rheometer having a cone with a diameter of 50 mm, an angle of at a temperature of 25° C. and a shear rate sweep from 1 1/s to 10 1/s by linear regression.

The organosilicon compounds in accordance with the present invention are commercially available products or can be prepared by methods known in the art.

Preferably, the composition of the present invention contains component (A) in an amount of 30 wt.-% or more to 90 wt.-% or less, more preferably 40 wt.-% or more to 85 wt.-% or less based on the total weight of the composition.

Component (B)

According to the present invention, the composition further comprises (B) at least one curing agent comprising a combination of n-propyltriacetoxysilane and methyltriacetoxysilane.

Surprisingly, it has been found that a combination of n-propyltriacetoxysilane and methyltriacetoxysilane inhibits crystallization during storage or handling of the composition. Accordingly, the composition of the present invention shows excellent storage stability at room temperature and even at temperatures down to −15° C.

Preferably, the curing agent comprises at least 50 wt.-%, more preferably at least 55 wt.-%, and in particular from 60 wt.-% or more to 85 wt.-% or less, of n-propyltriacetoxysilane based on the total weight of the curing agent.

Preferably, the curing agent comprises up to 50 wt.-%, more preferably up to 45 wt.-%, in particular from 15 wt.-% or more to 40 wt.-% or less, of methyltriacetoxysilane based on the total weight of the curing agent.

Optionally, the curing agent further comprises condensates of two or more molecules of n-propyltriacetoxysilane and/or methyltriacetoxysilane, i.e. siloxane oligomers obtainable through condensation of two or more molecules of n-propyltriacetoxysilane and/or methyitriacetoxysilane. The condensates may be homo-condensates, i.e. condensates of only one type of silane, or co-condensates, i.e. condensates of at least two types of silanes. Up to 30% of all Si atoms of the curing agent may be contained in condensates. The use of condensates of n-propyltriacetoxysilane and/or methyltriacetoxysilane further inhibits crystallization.

Optionally, the curing agent further comprises one or more curing agents other than n-propyltriacetoxysilane, methyltriacetoxysilane or condensates thereof. The additional curing agent may be any curing agent known in the art that is suitable to react with component (A) via condensation reaction. Preferably, the additional curing agent has at least three condensable radicals, such as, for example, silanes or siloxanes having at least three organyloxy groups.

In one embodiment, the additional curing agent is a compound of the formula (III)

Z_{c}SiR¹_{(4-c)} (III),

wherein

R¹ can be identical or different and is a monovalent, unsubstituted or substituted hydrocarbon radical, wherein one or more carbon atoms of the hydrocarbon radical may optionally be replaced with oxygen atoms,

Z can be identical or different and is a condensable radical, such as, for example, a hydrocarbon radical which is unsubstituted or substituted and which is bonded to the Si atom by way of an oxygen atom or nitrogen atom, and

c is 2, 3 or 4, preferably 3 or 4.

Preferably, Z is a OR² radical, wherein R² is an unsubstituted or substituted hydrocarbon radical, wherein one or more carbon atoms of the hydrocarbon radical may optionally be replaced with heteroatoms such as oxygen, nitrogen or sulfur.

Examples of Z are alkoxy radicals, such as methoxy, ethoxy, n-propoxy, isopropoxy, n-butoxy, isobutoxy, sec-butoxy, tert-butoxy, and 2-methoxyethoxy; acyloxy radicals, such as acetoxy; and enoxy radicals, such as 2-propenoxy. More preferably, Z is acetoxy.

In another embodiment, the additional curing agent is a condensate of two or more molecules of the compounds of the formula (III). The condensates may be homo-condensates, i.e. condensates of one type of compounds of the formula (III), or co-condensates, i.e. condensates of at least two different types of compounds of the formula (III). In a preferred embodiment, the condensates contain 2 to 10 silicon atoms, i.e. condensates obtainable through condensation of 2 to 10 molecules of one or more compounds of formula (III). More preferably, the condensates are obtainable through condensation of 4 to 8, even more preferably, 6 molecules.

Due to their preparation process compounds of formula (III) may contain a small proportion of Si-bonded hydroxy groups. Preferably, at most 5 wt.-%, more preferably at most 1 wt.-%, of all Si-bonded radicals of formula (III) compounds are hydroxyl groups.

Examples of radical R¹ are the monovalent examples mentioned above for radical R. Preferably, R¹ is a hydrocarbon radical having from 1 to 12 carbon atoms. More preferably, R¹ is selected from ethyl, methyl and vinyl.

Preferably, the additional curing agents are selected from the group consisting of ethyltriacetoxysilane, vinyltriacetoxysilane, dimethyldiacetoxysilane, methylvinyl-diacetoxysilane, and partial homo- or co-condensates thereof.

The curing agents in accordance with the present invention are commercially available products or can be prepared by processes known in the art. For example, methods for the production of carbonyloxy silanes are reported in DE 196 49 028 A1.

Preferably, the composition of the present invention comprises component (B) in an amount of from 0.01 to 20 parts by weight, more preferably from 2 to 15 parts by weight, even more preferably from 4 to 10 parts by weight, based on 100 parts by weight of component (A).

Preferably, the composition of the present invention contains component (B) in an amount of 1 wt.-% or more to 10 wt.-% or less, more preferably 2.5 wt.-% or more to 6 wt.-% or less based on the total weight of the composition.

For the sake of clarity, component (B) is different from component (A).

Component (C)

According to the present invention, the composition further comprises (C) at least one curing catalyst comprising an organotin compound.

Preferably, the curing catalyst is selected from the group consisting of tin 2-ethylhexanoate, di-n-butyltin diacetate, di-n-butyltin dilaurate, di-n-butyltin dioctoate, diphenytin diacetate, di-n-octyltin dilaurate, di-n-octyttin diacetate, di-n-butyftin oxide, di-n-octyltin oxide, combinations of one or more of the foregoing organotin compounds, and reaction products of the foregoing organotin compounds with alkoxysilanes, such as, for example, tetraethoxysilane, metyltrimethoxysilane or vinyltrimethoxysilane. More preferably, the curing catalyst is di-n-butyltin diacetate or a reaction product of di-n-butyltin diacetate and tetraethoxysilane.

Preferably, the composition of the present invention comprises component (C) in an amount of from 0.001 to 2 parts by weight, more preferably from 0.001 to 0.5 parts by weight, based on 100 parts by weight of component (A).

Preferably, the composition of the present invention contains component (C) in an amount of 0.001 wt.-% or more to 0.1 wt.-% or less based on the total weight of the composition.

Additional Components

In addition to the components (A), (B) and (C) described above, the composition of the present invention may optionally further comprise one or more components selected from the group consisting of

(D) at least one plasticizer,

(E) at least one filler,

(F) at least one coupling agent, and

(G) at least one further additive.

Examples of plasticizers (D) are dimethylpolysiloxanes which are liquid at room temperature and which have been end-capped by trimethylsiloxy groups, preferably those having a viscosity at 25° C. in the range from 50 to 1,000 mPas, organopolysiloxanes which are liquid at room temperature and which consist essentially of —SiO_{3/2} units and ═SiO_{1/2} units, known as T and M units, and high-boiling-point hydrocarbons, e.g. paraffin oils or mineral oils which consist essentially of naphthenic and paraffinic units. Preferably, the hydrocarbon based plasticizers have a kinematic viscosity between 3 and 8 mm²/s at 40° C. and an initial boiling point of 220° C. to 300° C.

Preferably, the composition of the present invention comprises plasticizer(s) (D) in an amount of from 0 to 300 parts by weight, more preferably from 10 to 200 parts by weight, even more preferably from 20 to 100 parts by weight, based on 100 parts by weight of component (A).

Preferably, the composition of the present invention contains component (D) in an amount of 0 wt.-% or more to 50 wt.-% or less, more preferably 10 wt.-% or more to 40 wt.-% or less based on the total weight of the composition.

For the sake of clarity, component (D) is different from components (A), (B), (C), (E), (F) and (G).

Examples of fillers (E) are non-reinforcing fillers with resistance to organic acids, i.e. fillers having a BET surface area of 50 m²/g or less, e.g. quartz, diatomaceous earth, coated calcium silicate, zirconium silicate, zeolites, metal oxide powders, such as aluminum oxides, titanium oxides, iron oxides, or zinc oxides, or mixed oxides of these, barium sulfate, gypsum, anhydrite, talcum, silicon nitride, silicon carbide, boron nitride, glass powder, and plastics powder, such as polyacrylonitrile powder; reinforcing fillers, i.e. fillers having a BET surface area of more than 50 m²/g, such as fumed silica, precipitated silica, carbon black, such as furnace black and acetylene black, and silicon-aluminum mixed oxides having a high BET surface area; fibrous fillers, such as glass and also dendritic fibers. The fillers mentioned may have optionally been hydrophobicized, for example by treatment with organosilanes, with organosiloxanes or with stearic acid, or by etherification of the hydroxy groups to give alkoxy groups. Preferably, the filler is selected from the group consisting of hydrophilic fumed silica, quartz, anhydrite, talcum and combinations thereof.

Preferably, the composition of the present invention comprises filler(s) (E) in an amount of from 0 to 300 parts by weight, more preferably from 1 to 200 parts by weight, even more preferably from 5 to 200 parts by weight, based in each case on 100 parts by weight of organosilicon compound (A).

Preferably, the composition of the present invention contains component (E) in an amount of 0 wt.-% or more to 50 wt.-% or less, more preferably 5 wt.-% or more to 30 wt.-% or less based on the total weight of the composition.

For the sake of clarity, component (E) is different from components (A), (B), (C), (D), (F) and (G).

Examples of the coupling agents (F) used in the inventive compositions are silanes and organopolysiloxanes having functional groups which are capable of undergoing further cross-linking reactions, for example, those having glycidoxypropyl, or methacryloxypropyl radicals.

Preferably, the composition of the present invention comprises coupling agent(s) (F) in an amount of from 0 to 50 parts by weight, more preferably from 0.5 to 20 parts by weight, even more preferably from 0.5 to 5 parts by weight, based in each case on 100 parts by weight of organosilicon compound (A).

Preferably, the composition of the present invention contains component (F) in an amount of 0 wt.-% or more to 3 wt.-% or less, more preferably 0.1 wt.-% or more to 1.5 wt.-% or less based on the total weight of the composition.

For the sake of clarity, component (F) is different from components (A), (B), (C), (D), (E) and (G).

Examples of additives (G) are pigments, dyes, odorants, oxidation inhibitors, agents for influencing electrical properties, e.g. conductive carbon black, flame-retardant agents, light stabilizers, fungicides, agents for prolonging skin formation time, such as silanes having an SiC-bonded mercaptoalkyl radical, cell-generating agents, e.g. azodicarbonamide, heat stabilizers, scavengers, such as silylamides or silazanes containing Si—N, co-catalysts, such as Lewis acids and Brönsted acids, e.g. sulfonic acids, phosphoric acids, phosphoric esters, phosphonic acids and phosphonic esters, viscosity modifiers, e.g. phosphoric esters, polyalkyleneglycols, oligo- or polyalkyleneglycol modified organic oils, organic solvents, such as alkyl aromatics, organopolysiloxanes other than those of component (A), adhesion promoters, and diluents.

Preferably, the composition of the present invention comprises additive(s) (G) in an amount of from 0 to 100 parts by weight, more preferably from 0.01 to 30 parts by weight, even more preferably from 0.3 to 10 parts by weight, based in each case on 100 parts by weight of organosilicon compound (A).

Preferably, the composition of the present invention contains component (G) in an amount of 0 wt.-% or more to 5 wt.-% or less, more preferably 0.025 et.-% or more to 2.0 wt.-% or less based on the total weight of the composition.

For the sake of clarity, component (G) is different from components (A), (B), (C), (D), (E), and (F).

In one embodiment, the composition of the present invention comprises a one-part room-temperature curable composition comprising:
(A) at least one organosilicon compound containing condensable groups;
(B) at least one curing agent comprising a combination of n-propyl-triacetoxysilane and methyltriacetoxysilane;
(C) at least one curing catalyst comprising an organotin compound;

optionally
(D) at least one plasticizer;

optionally
(E) at least one filler;

optionally
(F) at least one coupling agent; and

optionally
(G) at least one further additive.

In a further embodiment, the composition of the present invention comprises,
(A) at least one organosilicon compound containing at least two condensable groups selected from hydroxyl groups, acetoxy groups or a combination thereof;
(B) at least one curing agent comprising a combination of n-propyltriacetoxysilane, methyitriacetoxysilane and condensates of two or more molecules of n-propyltriacetoxysilane, methyltriacetoxysilane or a combination thereof; and
(C) at least one curing catalyst selected from the group consisting of tin 2-ethylhexanoate, di-n-butyltin diacetate, di-n-butyltin dilaurate, dibutyltin dioctoate, diphenytin diacetate, dioctyltin dilaurate, dioctyltin diacetate, di-n-butyltin oxide, dioctyltin oxide, combinations of one or more of the foregoing organotin compounds and reaction products of the foregoing organotin compounds with alkoxysilanes.

In a further embodiment, the composition of the present invention comprises
(A) at least one organosilicon compound selected from the group consisting of
   (AcO)₂MeSiO[SiMe₂O]₂₀₀₋₂₀₀₀SiMe(OAc)₂,
   (HO)Me₂SiO[SiMe₂O]₂₀₀₋₂₀₀₀SiMe₂(OH),
   (HO)MeViSiO[SiMe₂O]₂₀₀₋₂₀₀₀SiMeVi(OH),
   (AcO)₂ViSiO[SiMe₂O]₂₀₀₋₂₀₀₀SiVi(OAc)₂,
   (AcO)₂EtSiO[SiMe₂O]₂₀₀₋₂₀₀₀SiEt(OAc)₂,
   (AcO)₂PrSiO[SiMe₂O]₂₀₀₋₂₀₀₀SiPr(OAc)₂,
   (AcO)₂MeSiO[SiMe₂O]₂₀₀₋₂₀₀₀SiPr(OAc)₂,
   (AcO)₂PrSiO[SiMe₂O]₂₀₀₋₂₀₀₀SiEt(OAc)₂,
   and combinations thereof,

wherein Me is a methyl radical, Et is an ethyl radical, Pr is a n-propyl radical, Vi is a vinyl radical, and Ac is an acetoxy radical;
(B) at least one curing agent comprising a combination of n-propyltriacetoxysilane and methyltriacetoxysilane; and
(C) at least one curing catalyst selected from the group consisting of tin 2-ethylhexanoate, di-n-butyltin diacetate, di-n-butyltin dilaurate, dibutyltin dioctoate, diphenyltin diacetate, dioctyltin dilaurate, dioctyltin diacetate, di-n-butyltin oxide, dioctyltin oxide, combinations of one or more of the foregoing organotin compounds and reaction products of the foregoing organotin compounds with alkoxysilanes

In a further embodiment the composition of the present invention comprises, preferably consists of,
(A) at least one polyorganosiloxane of the following formula (II):

Y_{3-f}R_{f}Si—(SiR₂—O)ₑ—SiR_{f}Y_{3-f} (II),

wherein

R can be identical or different and is a substituted or unsubstituted hydrocarbon radical, wherein one or more carbon atoms of the hydrocarbon radical may optionally be replaced with oxygen atoms,

Y can be identical or different and is a hydroxy radical or acyloxy radical,

e is from 30 to 3000, and

f is 1 or 2;
(B) at least one curing agent comprising a combination of n-propyltriacetoxysilane and methyltriacetoxysilane;
(C) at least one curing catalyst selected from the group consisting of tin 2-ethylhexanoate, di-n-butyltin diacetate, di-n-butyltin dilaurate, dibutyltin dioctoate, diphenyltin diacetate, dioctyltin dilaurate, dioctyltin diacetate, di-n-butyltin oxide, dioctyltin oxide, combinations of one or more of the foregoing organotin compounds and reaction products of the foregoing organotin compounds with alkoxysilanes; and
one or more components selected from the group consisting of
(D) at least one plasticizer selected from the group consisting of trimethylsiloxy-terminated dimethylpolysiloxanes, organopolysiloxanes which consist essentially of —SiO_{3/2} units and =SiO_{1/2} units, and paraffin oils or mineral oils consisting essentially of naphthenic and paraffinic units;
(E) at least one filler selected from the group consisting of hydrophilic fumed silica, quartz, anhydrite, talcum and combinations thereof;
(F) at least one coupling agent selected from the group consisting of silanes containing glycidoxypropyl, or methacryloxypropyl radicals; and
(G) at least one further additive selected from the group consisting of pigments, dyes, odorants, oxidation inhibitors, agents for influencing electrical properties, flame-retardant agents, light stabilizers, fungicides, agents for prolonging skin formation time, cell-generating agents, heat stabilizers, scavengers, Lewis acids, Brönsted acids, viscosity modifiers, organic solvents, organopolysiloxanes other than those of component (A), adhesion promoters, and diluents.

The compositions of the present invention are preferably viscous to pasty compositions. Preferable, the viscosity of the compositions is 400,000 m·Pas or higher, measured under the conditions mentioned above at a shear rate of 0.1 l/s. A viscous to pasty consistency is advantageous for the easy handling of the compositions when they are applied to the desired substrate.

The compositions of the present invention can be prepared by conventional methods known in the art. In particular, all of the components can be mixed with one another in any desired sequence. This mixing can be carried out under standard conditions, i.e. at room temperature and at the pressure of the ambient atmosphere, i.e. from about 900 to 1,100 hPa. If desired, mixing may also be carried out at higher temperatures, e.g. at temperatures in the range from 35° C. to 135° C. If desired, mixing may also be partially or entirely carried out under reduced pressure, e.g. at an absolute pressure of from 30 to 500 hPa, in order to remove volatile compounds or air.

Usually, the normal water content of ambient air is sufficient for cross-linking the compositions of the present invention. If desired, cross-linking may also be carried out in air having an increased humidity level. Preferably, crosslinking is carried out in an atmosphere having a water content of 1 g/m³ to 80 g/m³ air, more preferably 2 g/m³ to 40 g/m³ air, even more preferably 5 g/m³ to 25 g/m³ air.

Preferably, cross-linking takes place at room temperature. If desired, it may also be carried out at temperatures higher or lower than room temperature, e.g. at from −5° C. to 15° C. or from 30° C. to 50° C.

The curing of the composition is preferably carried out at a pressure of from 100 to 1,100 hPa, in particular at the pressure of the ambient atmosphere, i.e. from 900 to 1,100 hPa.

The present invention also provides moldings produced via cross-linking of the compositions of the present invention. Such moldings can be produced by any method known in the art.

The inventive compositions can be used for any intended purpose for which it is possible to use compositions which can be stored in the absence of water and which crosslink to give elastomers at room temperature in the presence of water.

The composition of the present invention is particularly suitable for applications such as sealing of joints and cavities, in particular vertically running joints and/or cavities having a gap width of from 10 to 40 mm. Such joints and cavities may be present in buildings, land vehicles, watercraft, or aircraft. The composition of the present invention can further be used as an adhesive or putty composition, for example, in window construction or in the production of display cabinets. Moreover, the composition of the present invention can further be used for the production of protective coatings, in particular coatings for surfaces having continuous exposure to fresh or salt water, or anti-slip coatings. Furthermore, the composition of the present invention can further be used for the production of elastomeric moldings, for example, for insulation of electrical or electronic devices.

Advantageously, the compositions of the present invention have improved storage stability while having excellent skin formation time, viscosity and other physical properties. In particular, the compositions of the present invention can be used even in warm and humid climatic conditions. Furthermore, they have excellent handling properties in a wide variety of applications.

### EXAMPLES

In the examples described below, all viscosities are measured at a temperature of 25° C. unless otherwise stated. Unless otherwise stated, the examples below are carried out at the pressure of the ambient atmosphere, i.e. at 900 to 1,100 hPa, and at room temperature, i.e. at about 23° C., or at the temperature which is developed when the reactants are combined at room temperature without additional heating or cooling, and at about 50% relative humidity. All of the parts and percentages data are moreover based on weight unless otherwise stated.

The rheology of the curable compositions is determined according to DIN 54458 using an amplitude sweep with plate-plate array. The plate has a diameter of 25 mm, is used with a gap width of 0.5 mm and a frequency of 10 Hz at 25° C.

Viscosity η* (γ=0.1%) refers to the complex viscosity [mPa·s] at a deformation of 0.1% according to DIN 54458. Viscosity η* (γ=100%) refers is the complex viscosity [mPa·s] at a deformation of 100% according to DIN 54458. The flow point refers to the critical shear stress value above at which a sample rheologically behaves like a liquid. The flow point is defined herein as shear stress [Pa] at tan δ=1.

### Comparative Example 1

520 g of α,ω-dihydroxypolydimethylsiloxane having a viscosity of 80,000 mPa·s, 150 g of a trimethylsilyl-terminated polydimethylsiloxane having a viscosity of 1,000 mPa·s, and 32 g of methyltriacetoxysilane (melted before use) were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyltin diacetate was admixed under vacuum. The resulting composition was then filled into a moisture-proof container for further storage. After 4 weeks of storage at 5° C. the composition showed needle shaped crystals, identified as methyltriacetoxysilane.

### Comparative Example 2

500 g of a α,ω-dihydroxypolydimethysiloxane having a viscosity of 80,000 mPa·s, 150 g of a trimethylsilyl-terminated polydimethylsiloxane having a viscosity of 1,000 mPa·s and a liquid preblend of 22 g of ethyltriacetoxysilane and 10 g of methyltriacetoxysilane were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyltin diacetate was admixed under vacuum. The resulting composition was then filled into a moisture-proof container for further storage. After 4 weeks of storage at 5° C. the composition showed needle shaped crystals, identified as methyltriacetoxysilane. The preblend of ethyltriacetoxysilane and methyl-triacetoxysilane itself showed cloudy precipitation after 4 weeks of storage at room temperature.

### Comparative Example 3

500 g of a α,ω-dihydroxypolydimethylsiloxane having a viscosity of 80,000 mPa·s, 150 g of a trimethylsilyl-terminated polydimethylsiloxane having a viscosity of 1,000 mPa·s and 32 g of a liquid partially oligomeric methyltriacetoxysilane with 27 mol % dimers and 4 mol % higher oligomers were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyltin diacetate was admixed under vacuum. The resulting composition was then filled into a moisture-proof container for further storage. After 4 weeks of storage at 5° C. the composition remained homogeneous.

### Example 1

500 g of α,ω-dihydroxypolydimethylsiloxane having a viscosity of 80,000 mPa·s, 150 g of a trimethylsilyl-terminated polydimethylsiloxane having a viscosity of 1,000 mPa·s and a homogeneous preblend of 22 g n-propyltriacetoxysilane and 10 g methyltriacetoxysilane were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyltin diacetate was admixed under vacuum. The resulting composition was then filled into a moisture-proof container for further storage. After 4 weeks of storage at 5° C. the composition remained homogeneous and did not show any crystals.

### Example 2

520 g of a α,ω-dihydroxypolydimethylsiloxane having a viscosity of 80,000 mPa·s, 150 g of a trimethylsilyl-terminated polydimethylsiloxane having a viscosity of 1,000 mPa·s, and 32 g of a partially oligomerized homogeneous cross-linking mixture containing 30 mol % methyltriacetoxysilane, 47 mol % n-propyltriacetoxysilane, 22 mol % dimers of said silanes and 1 mol % higher oligomers of said silanes were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyftin diacetate was admixed under vacuum. The resulting composition was then filled into a moisture-proof container for further storage. After 4 weeks of storage at 5° C. the composition remained homogeneous and did not show any crystals.

### Example 3

520 g of a α,ω-dihydroxypolydimethylsiloxane having a viscosity of 80,000 mPa·s, 190 g of a hydrocarbon mixture having a kinematic viscosity of 6.2 mm²/s at 40° C., a viscosity-gravity constant (VGC) of 0.79 and a boiling range of from 300 to 370° C., and a homogeneous preblend of 22 g of n-propyltriacetoxysilane and 10 g of methyltriacetoxysilane were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 0.4 g di-n-butyltin diacetate was admixed under vacuum. The resulting composition was then filled into a moisture-proof container for further storage. After 4 weeks of storage at 5° C. the composition remained homogeneous and did not show any crystals.

### Example 4

520 g of a α,ω-dihydroxypolydimethylsiloxane having a viscosity of 80,000 mPa·s, 190 g of a hydrocarbon mixture having a kinematic viscosity of 6.2 mm²/s at 40° C., a viscosity-gravity constant (VGC) of 0.79 and a boiling range of from 300 to 370° C., and a homogeneous blend of 22 g of n-propyltriacetoxysilane and 10 g of methyltriacetoxysilane were mixed for 5 minutes in a planetary mixer. Subsequently, 60 g of fumed silica having a specific surface area of 150 m²/g (commercially available under the trademark HDK®V15 from Wacker Chemie AG, Germany) was incorporated into the mixture. After 20 minutes of homogenization in vacuo, 2.4 g of polyalkylene glycol (molecular weight of 600 g/mol) consisting of 13 ethylene oxide units and 1 propylene oxide unit, and 0.4 g di-n-butyltin diacetate were admixed under vacuum. The resulting composition was then filled into a moisture-proof container for further storage. After 4 weeks of storage at 5° C. the composition remained homogeneous and did not show any crystals.

In order to determine the rheological and mechanical properties of the materials, the compositions of Comparative Examples 1 to 3 and Examples 1 to 4 were cured for 14 days at a temperature of 23° C. and a relative humidity of 50% at standard atmospheric pressure (1013 mbar) to give elastomers.

The skin formation time has been determined by applying the composition onto a substrate and measuring the period of time until a skin has been formed on the surface of the composition. Skin formation is deemed to be completed if the surface of the composition can be contacted with a laboratory spatula and upon removal of the spatula does not form any strings or remains on the spatula.

The physical properties of the cured elastomers were tested in accordance with standard methods. Shore A hardness was measured according to DIN 53505. Modulus, Tensile strength and Elongation at break were measured according to DIN 53504 S3. Rheological properties were measured according to DIN 54458. Resistance to flow was measured according to DIN EN ISO 7390. Results are shown in Table 1.

TABLE 1
Results

| | Comparative | Comparative | Comparative | | | | |
|---|---|---|---|---|---|---|---|
| | Example 1 | Example 2 | Example 3 | Example 1 | Example 2 | Example 3 | Example 4 |
| Viscosity η* (γ = 0.1%) | 922,000 | 860,300 | 1,286,200 | 807,000 | 826,000 | 519,000 | 680,200 |
| [mPa · s] | | | | | | | |
| Flow point | 2,650 | 2,340 | 2,810 | 1,770 | 1,750 | 1,830 | 1,790 |
| (shear stress at tan d = 1) | | | | | | | |
| [Pa] | | | | | | | |
| Viscosity η* (γ = 100%) | 102,000 | 98,500 | 136,100 | 85,500 | 87,400 | 65,700 | 63,400 |
| [mPa · s] | | | | | | | |
| Skin formation time after | 20 | 24 | 18 | 30 | 30 | 40 | 42 |
| production | | | | | | | |
| [min] | | | | | | | |
| Skin formation time after 2 | 18 | 26 | 35 | 33 | 32 | 37 | 45 |
| weeks of storage at 70° C. | | | | | | | |
| [min] | | | | | | | |

To summarize, the comparative examples either show crystallization (comparative examples 1 and 2) or, when using non-crystallising oligomeric methyltriacetoxysilane, a significant change in viscosity and skin formation time during storage (comparative example 3). The inventive compositions do not show crystallization and have stable curing properties under accelerated ageing.

1.-12. (canceled)

13. A one-part room-temperature curable composition, comprising:
(A) at least one organosilicon compound containing condensable groups;
(B) at least one curing agent comprising a combination of n-propyltriacetoxysilane and methyltriacetoxysilane; and
(C) at least one curing catalyst comprising an organotin compound.

14. The composition of claim 13, wherein the curing agent (B) comprises at least 50 wt. % of n-propyltriacetoxysilane based on the total weight of the curing agent.

15. The composition of claim 13, wherein the curing agent (B) further comprises condensates of two or more molecules of n-propyltriacetoxysilane, methyltriacetoxysilane or a combination thereof.

16. The composition of claim 15, wherein up to 30% of all Si atoms of the curing agent are contained in the condensates.

17. The composition of claim 13, wherein the curing agent (B) further comprises a compound other than n-propyltriacetoxysilane, methyltriacetoxysilane or condensates thereof, said compound having the formula (III):
Z_{c}SiR¹_{(4-c)} (III),
wherein
R¹ each is identical or different and is a monovalent, unsubstituted or substituted hydrocarbon radical, wherein one or more carbon atoms of the hydrocarbon radical are optionally replaced with oxygen atoms,
Z each is identical or different and is a condensable radical, and
c is 2, 3 or 4.

18. The composition of claim 13, wherein the condensable groups of organosilicon compound (A) are selected from hydroxyl groups, acetoxy groups, or a combination thereof.

19. The composition of claim 13, wherein the organosilicon compound (A) comprises units of the formula (I):
RₐY_{b}SiO_{(4-a-b)/2} (I),
wherein
R each is identical or different and is a substituted or unsubstituted hydrocarbon radical, wherein one or more carbon atoms of the hydrocarbon radical are optionally replaced with oxygen atoms,
Y each is identical or different and is a hydroxy radical or acyloxy radical,
a is 0, 1, 2, or 3, and
b is 0, 1, 2, or 3,
with the proviso that the sum of a and b is less than or equal to 3 and at least two Y radicals are present per molecule of the organosilicon compound.

20. The composition of claim 13, wherein the organosilicon compound (A) is a polyorganosiloxane of the formula (II):
Y_{3-f}R_{f}SiO—(SiR₂O)ₑ—SiR_{f}Y_{3-f} (II),
wherein
e is from 30 to 3000, and
f is 1 or 2.

21. The composition of claim 13, wherein the curing catalyst is selected from the group consisting of tin 2-ethylhexanoate, di-n-butyltin diacetate, di-n-butyltin dilaurate, di-n-butyltin di-n-octoate, diphenyltin diacetate, di-n-octyltin dilaurate, di-n-octyltin diacetate, di-n-butyltin oxide, di-n-octyltin oxide, combinations of one or more of the foregoing organotin compounds, and reaction products of the foregoing organotin compounds with alkoxysilanes, and combinations thereof.

22. The composition of claim 13, wherein the composition further comprises one or more components selected from the group consisting of
(D) plasticizers,
(E) fillers,
(F) coupling agents, and
(G) further additives.

23. The composition of claim 13, wherein the composition further comprises fumed silica.

24. A molding produced by cross-linking a composition of claim 13.
